(19) United States
(12) Patent Application Publication
(10) Pub. No.: US 2005/0111352 A1
(43) Pub. Date: May 26, 2005

(54) Method and system for monitoring a network containing routers using a backup routing protocol

(76) Inventors: Boon Ho, Fort Collins, CO (US); Srikanth Natarajan, Fort Collins, CO (US); Dipankar Gupta, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/717,521

(22) Filed: Nov. 21, 2003

(51) Int. Cl. G01R 31/08; H04L 12/28

(52) U.S. Cl. 370/219; 370/351

(57) ABSTRACT

A method for monitoring a network containing routers using a backup routing protocol and organized in at least one backup router group, includes discovering a topology object model of the routers, detecting a condition of the at least one backup router group based on at least one threshold value, and displaying an indication of the detected condition. A machine readable medium can include software or a computer program or programs for causing a computing device to perform the method.

### BACKGROUND

One way to achieve near-100 percent network uptime is to use Hot Standby Routing Protocol (HSRP), a proprietary protocol from Cisco, or Virtual Router Redundancy Protocol (VRRP) defined in IETF (Internet Engineering Task Force) document RFC (Request for Comments) 2338, dated April 1998. VRRP provides network redundancy for Internet Protocol (IP) networks, in an effort to ensure that user traffic immediately and transparently recovers from first hop failures in network edge devices or access circuits of a network. By sharing an IP address and a MAC (Layer 2) address, two or more routers can act as a single “virtual” router group. The members of the virtual router group continually exchange status messages, so that if a first router goes out of commission or becomes otherwise unavailable for planned or unplanned reasons, a second router in the group can assume the routing responsibilities of the first router. Hosts on the network continue to forward IP packets to a consistent IP and MAC address, and the changeover of routing devices doing the routing is transparent.

The term Backup Routing Protocol is used to refer to a class of backup routing protocols including HSRP and VRRP.

Cisco's Hot Standby Routing Protocol (HSRP) provides automatic router backup when it is configured on Cisco routers that run the Internet Protocol (IP) over Ethernet, Fiber Distributed Data Interface (FDDI), and Token Ring local-area networks (LANs). For IP, HSRP allows one router to automatically assume the function of a second router if the second router fails. HSRP is useful for example when the users on one subnet require continuous access to resources in the network.

Consider for example a network where subnets or segments are located in Tokyo, Paris, and New York. The Tokyo subnet includes Routers A and B, the Paris subnet includes Routers C and D, and the New York subnet includes Routers E and F, where Routers A and C are responsible for handling packets between the Tokyo subnet and the Paris subnet, Routers D, F are responsible for handling packets between the Paris subnet and the New York subnet, and Routers B, E are responsible for handling packets between the Tokyo subnet and the New York subnet. If the connection between Routers A and C (Tokyo, Paris) goes down or if either router becomes unavailable, fast converging routing protocols, such as the Enhanced Interior Gateway Routing Protocol (Enhanced IGRP) and Open Shortest Path First (OSPF) can respond within seconds so that Router B is prepared to transfer packets that would otherwise have gone through Router A. Router B can, for example, transfer packets to the Paris subnet or segment via the New York subnet or segment using the Routers E, F and D.

However, in spite of fast convergence, if the connection between Router A and Router C goes down, or if either router becomes unavailable, a user “Pat” on the Tokyo segment might not be able to communicate with a user “Marceau” on the Paris segment even after the routing protocol has converged. This is because IP hosts, such as Pat's workstation, usually do not participate in routing protocols. Instead, they are often configured statically with the address of a single router, such as Router A. Until someone manually modifies the configuration of Pat's host to use the address of Router B instead of Router A, Pat cannot communicate with Marceau.

Some IP hosts use proxy Address Resolution Protocol (ARP) to select a router. If Pat's workstation were running proxy ARP, it would send an ARP request for the IP address of Marceau's workstation. Router A would reply on behalf of Marceau's workstation and would give to Pat's workstation its own media access control (MAC) address (instead of the IP address of Marceau's workstation). With proxy ARP, Pat's workstation behaves as if Marceau's workstation were connected to the same segment of the network as Pat's workstation. If Router A fails, Pat's workstation will continue to send packets destined for Marceau's workstation to the MAC address of Router A even though those packets have nowhere to go and are lost. Pat either waits for ARP to acquire the MAC address of Router B by sending another ARP request or reboots the workstation to force it to send an ARP request. In either case, for a significant period of time, Pat cannot communicate with Marceau—even though the routing protocol has converged, and Router B is prepared to transfer packets that would otherwise go through Router A.

Some IP hosts use the Routing Information Protocol (RIP) to discover routers, which can be slow to adapt to changes in the topology. If Pat's workstation is configured to use RIP, 3 to 10 minutes might elapse before RIP makes another router available.

Some newer IP hosts use the ICMP Router Discovery Protocol (IRDP) to find a new router when a route becomes unavailable. A host that runs IRDP listens for hello multicast messages from its configured router and uses an alternate router when it no longer receives those hello messages. If Pat's workstation were running IRDP, it would detect that Router A is no longer sending hello messages and would start sending its packets to Router B.

For IP hosts that do not support IRDP, Cisco's HSRP provides a way to keep communicating when a router becomes unavailable. HSRP allows two or more HSRP-configured routers to use the MAC address and IP network address of a virtual router. The virtual router does not physically exist; instead, it represents the common target for routers that are configured to provide backup to each other. The Tokyo segment of the WAN can be configured for HSRP so that each actual router is configured with the MAC address and the IP network address of the virtual router.

For example, the MAC address of the virtual router can be 0000.0c07.ac01, and the virtual IP address of the virtual router can be 192.1.1.3. The Tokyo subnet's IP address can be 192.1.1.0, the Router A can have an IP address 192.1.1.1 for its interface with the Tokyo subnet and an IP address 192.3.1.1 for its interface with/direct to the Paris subnet (Router C), and the Router B can have an IP address 192.1.1.2 for its interface with or to the Tokyo subnet and an IP address 192.2.2.1 for its interface with/toward the New York subnet (Router E).

When HSRP is configured on a router, the router automatically selects one of the virtual MAC addresses from a range of addresses in the Cisco IOS software that is within the range of Cisco's MAC address block. Ethernet and FDDI LANs use one of the preassigned MAC addresses as a virtual MAC address. Token Ring LANs use a functional address as a virtual MAC address.

In the example above, instead of configuring the hosts on the Tokyo segment 192.1.1.0 with the IP address of Router A, the hosts are configured with the IP address of the virtual router (e.g., 192.1.1.3) as their default router. When Pat's workstation sends packets to Marceau's workstation on the Paris segment, it sends them to the MAC address of the virtual router.

In the example, Router A can be configured as the active router and Router B can be configured as the standby router. The Router A is configured with the IP address and MAC address of the virtual router and sends any packets addressed to the virtual router out interface 192.3.1.1 to the Paris segment. As the standby router, Router B is also configured with the IP address and MAC address of the virtual router. If for any reason Router A stops transferring packets, the routing protocol converges, and Router B assumes the duties of Router A and becomes the active router. That is, Router B now responds to the virtual IP address and the virtual MAC address. Pat's workstation on the Tokyo segment continues to use the IP address of the virtual router to address packets destined for Marceau's workstation on the Paris segment, which Router B receives and sends to the Paris segment via the New York segment. Until Router A resumes operation, HSRP allows Router B to provide uninterrupted service to the users on the Tokyo segment that need to communicate with users on the Paris segment. While it is the active router, Router B also continues to perform its normal function of handling packets between the Tokyo segment and the New York segment.

HSRP also works when the hosts are configured for proxy ARP. When the active HSRP router receives an ARP request for a host that is not on the local LAN, the router replies with the MAC address of the virtual router. If the active router becomes unavailable or its connection to the remote LAN goes down, the router that becomes the active router receives packets addressed to the virtual router and transfers them accordingly.

Multigroup HSRP (MHSRP) is an extension of HSRP that allows a single router interface to belong to more than one Hot Standby group. MHSRP uses Cisco IOS Software Release 10.3 or later and is supported on routers that have special hardware that allows them to associate an Ethernet interface with multiple unicast Media Access Control (MAC) addresses. These routers are the AGS and AGS+routers and any router in the Cisco 7000 series. The special hardware allows a user to configure a single interface in an AGS, AGS+, or Cisco 7000 series router so that the router is the backup router for more than one Hot Standby group.

In an example, four Routers A, B, C, D are connected respectively by Ethernet interfaces 0 having addresses 1.0.0.1, 1.0.0.2, 1.0.0.3, and 1.0.0.4 to a network. The routers are organized in Groups such that the Ethernet interface 0 of Router A belongs to group 1, the Ethernet interface 0 of Router B belongs to groups 1, 2, and 3, the Ethernet interface 0 of Router C belongs to group 2, and the Ethernet interface 0 of Router D belongs to group 3. When these groups are established, it is possible to align them along departmental organizations. For example, where the routers are part of a company's network, group 1 might support an Engineering Department, group 2 might support a Manufacturing Department, and group 3 might support a Finance Department of the company.

Router B is configured as the active router for groups 1 and 2 and as the standby router for group 3. Router D is configured as the active router for group 3. If Router D fails for any reason, Router B will assume the packet-transfer functions of Router D and will maintain the ability of users in the Finance Department to access data on other subnets.

In both HSRP and MHSRP, a tracking feature can be used to adjust the Hot Standby priority of a router based on whether certain of the router's interfaces are available. A “tracked interface” is a monitored interface between a back end of a group and some port of a network, e.g. it is an interface that is not internal to the group. For example referring to the first example described above, where the Routers A, B on the Tokyo segment form a group, the interface 192.3.1.1 of the Router A toward the Paris segment can be a “tracked interface”, and the interface 192.2.2.1 of the Router B directed toward the New York segment can be a “tracked interface”. When a tracked interface becomes unavailable, the HSRP priority of the router is decreased, for example because unavailability of the interface makes the router less useful. Tracking can be used to automatically reduce the likelihood that a router that already has an unavailable key interface will become the active router. To configure tracking, the “standby track” interface configuration command can be used.

An example network for which tracking is configured includes three Routers A, B, C each with an Ethernet interface 0 having addresses 1.0.0.1, 1.0.0.2 and 1.0.0.3 respectively and directed toward a network 1.0.0.0. Each of the Routers A, B, C also includes a serial interface 0 directed outward toward an IP Wide Area Network (WAN), the interfaces respectively having addresses 3.0.0.1, 2.0.0.2 and 4.0.0.1. The Router A can be configured as the active router, and the Routers B, C can be configured as standby routers.

If Router A becomes unavailable and if serial interface 0 on Router B is available, Router B (assuming Router B has a priority that is lower than the priority of Router A but higher than the priority of Router C) will become the active router. However, if serial interface 0 on Router B becomes unavailable before Router A becomes unavailable, the HSRP priority of Router B will be reduced below that of Router C. If Router A then becomes unavailable, Router C will become the active router.

HSRP or MHSRP can be used when configuring load sharing. For example where Routers A, B connect to a Local Area Network (LAN) 1.0.0.0 via Ethernet interfaces 0 respectively having addresses 1.0.0.1 and 1.0.0.2, and each of the Routers A, B also connects via a different interface (for example, a serial interface) to an IP network or internetwork. In this example, the Router A is configured as an Active router for a group 1 and as a Standby router for group 2, and the Router B is configured as a Standby router for group 1 and as an Active router for group 2. Half of the workstations on the LAN are configured for Router A, and half of the workstations are configured for Router B.

Together, the configuration files for Routers A and B establish two Hot Standby groups. For group 1, Router A is the default active router, and Router B is the standby router. For group 2, Router B is the default active router, and Router A is the standby router. During normal operation, the two routers share the IP traffic load. When either router becomes unavailable, the other router becomes active and assumes the packet-transfer functions of the router that is unavailable. Interface configuration commands are used so that if a router goes down and then comes back up, preemption occurs and restores load sharing.

HSRP can be used with Routed Protocols such as AppleTalk, Banyan VINES, Novell IPX, DECnet and XNS. For example, HSRP can be configured in networks that, in addition to IP, run AppleTalk, Banyan VINES, and Novell IPX. AppleTalk and Novell IPX continue to function when the standby router becomes the active router, but they take time to adapt to topology changes.

In summary, HSRP and MHSRP use fault-tolerant routing of IP packets for networks in an effort to provide nonstop access by hosts on all segments to resources on all segments. To provide fault tolerance, HSRP and MHSRP use a routing protocol that converges rapidly, such as Enhanced Interior Gateway Routing Protocol (Enhanced IGRP).

### SUMMARY

A method for monitoring a network containing routers using a backup routing protocol and organized in at least one backup router group, includes discovering a topology object model of the routers, detecting a condition of the at least one backup router group based on at least one threshold value, and displaying an indication of the detected condition. A machine readable medium can include software or a computer program or programs for causing a computing device to perform the exemplary method.

A system for monitoring a network containing routers using a backup routing protocol and organized in at least one backup router group, includes a mechanism for discovering a topology object model of the routers and for detecting a condition of the at least one backup router group based on at least one threshold value, and a mechanism for displaying an indication of the detected condition.

A data structure for representing a backup routing protocol topology object model for a network includes at least one network node object representing an element in the network, at least one network interface object for each at least one network node object, the at least one network interface object representing an interface of the network element corresponding to the each at least one network node object, an address object for each at least one network interface object, representing an address of the corresponding interface, a backup routing protocol group object representing network elements organized in a backup routing protocol group, the backup routing protocol group object including a virtual address of the backup routing protocol group and real addresses of the network elements in the backup routing protocol group, and an address state object for each of the real addresses of the network elements in the backup routing protocol group, including a state of the corresponding address.

### BRIEF DESCRIPTION OF THE DRAWINGS

The accompanying drawings provide visual representations which will be used to more fully describe the representative embodiments disclosed herein and can be used by those skilled in the art to better understand them and their inherent advantages. In these drawings, like reference numerals identify corresponding elements and:

FIG. 1 illustrates an exemplary method for monitoring a network containing routers using a backup routing protocol, in accordance with an exemplary embodiment.

FIG. 2 illustrates an exemplary backup routing protocol topology object model in accordance with an exemplary embodiment.

FIG. 3 illustrates an exemplary system in accordance with an exemplary embodiment.

FIG. 4 illustrates an exemplary information display in accordance with an exemplary embodiment.

### DETAILED DESCRIPTION

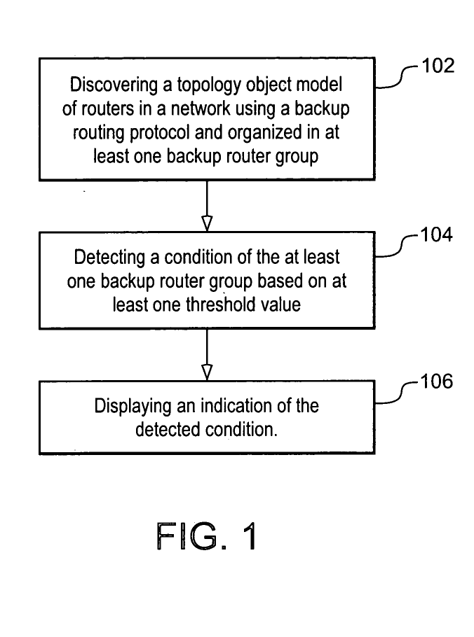

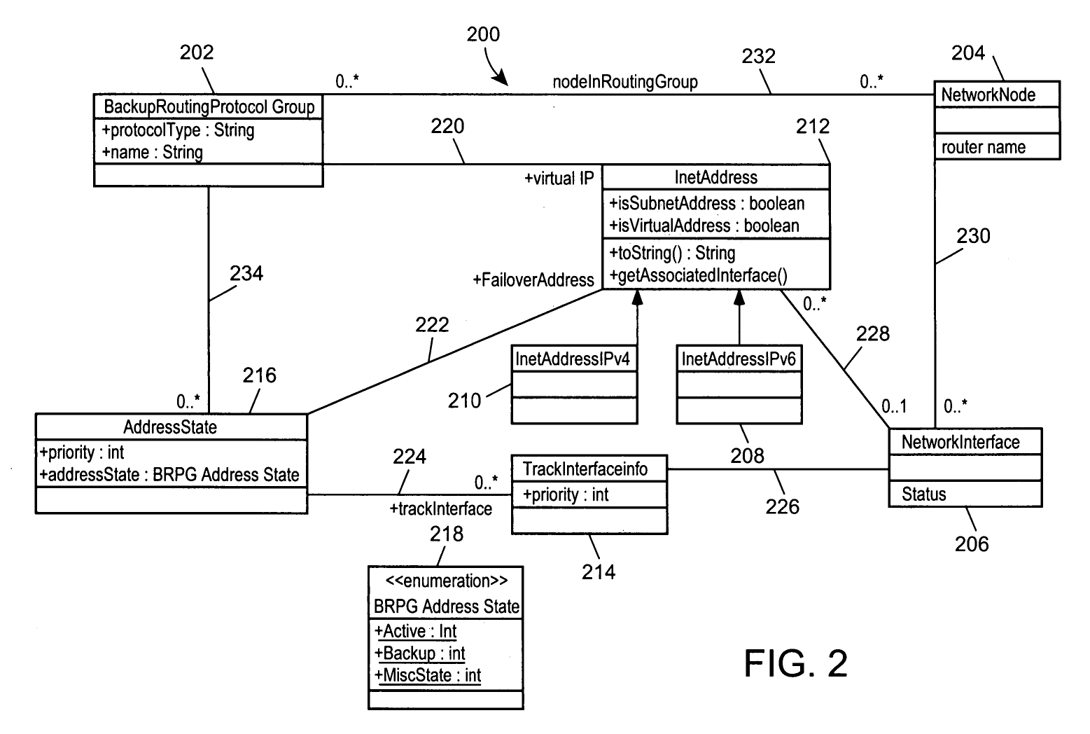

In an exemplary embodiment shown in FIG. 1, a topology object model, such as the model shown in FIG. 2, is used to monitor a network containing routers using a backup routing protocol. FIG. 1 shows that in a first step 102, discovering (for example, accessing, and/or-analyzing, and/or organizing-information, so that the information can be conveniently consumed by other functions, operations or users) a topology object model of routers in a network using a backup routing protocol and organized in at least one backup router group, by discovering or accessing the topology object model of the routers. A next step 104 shows detecting a condition of the at least one backup router group based on at least one threshold value, and a next step 106 shows displaying an indication of the detected condition.

The at least one threshold value can include a minimum number of available routers in a backup router group. The detecting can also be based on a number of backup router groups to which one of the routers belongs. The topology object model can also include, for each backup router group, at least one network router node; at least one network interface for each at least one network router node; at least one address for each at least one network interface; and a state of each one of the at least one address that is internal to the backup router group, as well as a state or indication thereof of at least one of the at least one address that is external to the backup router group. The detecting can also be based on a state of at least one of the at least one address that is external to the backup router group. The condition can be a minimum number of functional routers available in a corresponding backup router group, or can be a minimum number of functional routers available only in a corresponding backup router group.

The exemplary topology model 200 shown in FIG. 2 and described herein, models a Backup Routing Protocol including HSRP and VRRP and can provide storage of Backup Routing Protocol topology information, can provide the protocol state, and can allow a user or machine entity to navigate the topology information.

HSRP generally works in the following fashion. In HSRP, a priority scheme is used to determine which HSRP-configured router is to be the default active router. A router is configured as the active router, by assigning it a priority that is higher than the priority of all the other HSRP-configured routers. The default priority is 100, so if just one router is configured to have a higher priority, that router will be the default active router.

HSRP works by the exchange of multicast messages that advertise priority among HSRP-configured routers. When the active router fails to send a hello message within a configurable period of time, the standby router with the highest priority becomes the active router. The transition of packet-forwarding functions between routers is completely transparent to all hosts on the network.

HSRP-configured routers exchange three types of multicast messages:
Hello—The hello message conveys to other HSRP routers the router's HSRP priority and state information. By default, an HSRP router sends hello messages every three seconds.
Coup—When a standby router assumes the function of the active router, it sends a coup message.
Resign—A router that is the active router sends this message when it is about to shut down or when a router that has a higher priority sends a hello message.

At any time; HSRP-configured routers are in one of the following states:
Active—The router is performing packet-transfer functions.
Standby—The router is prepared to assume packet-transfer functions if the active router fails.
Speaking and listening—The router is sending and receiving hello messages.
Listening—The router is receiving hello messages.

In an example where an IP network 1.0.0.0 has-two routers A, B that are configured for HSRP, the Router A has an interface 1.0.0.1 toward the network 1.0.0.0 and an interface 3.0.0.1 toward an external network 3.0.0.0, and the Router B has an interface 1.0.0.2 toward the network 1.0.0.0 and an interface 2.0.0.2 toward an external network 2.0.0.0. The networks 3.0.0.0 and 2.0.0.0 can connect to a Host B via an internetwork, so that a Host A on the network 1.0.0.0 can communicate with the Host B via either the Router A or the Router B.

All hosts on the network 1.0.0.0 are configured to use the IP address of a virtual router (in this case, 1.0.0.3) as the default gateway. The command for configuring the default gateway depends on the host's operating system, TCP/IP implementation, and configuration. The configurations shown in this example use the Enhanced IGRP routing protocol, or use any routing protocol supported by the Cisco IOS software. Some configurations that use HSRP can use a routing protocol to converge when a topology change occurs. The standby router becomes active, but connectivity does not occur until the protocol converges.

In an exemplary HSRP network, a first Router A can have the following configuration:

hostname RouterA
!
interface ethernet 0
ip address 1.0.0.1 255.0.0.0
standby 1 ip 1.0.0.3
standby 1 preempt
standby 1 priority 110
standby 1 authentication denmark
standby 1 timers 5 15
!
interface ethernet 1
ip address 3.0.0.1 255.0.0.0
!
router eigrp 1
network 1.0.0.0
network 3.0.0.0

A second Router B can have the following configuration:

hostname RouterB
!
interface ethernet 0
ip address 1.0.0.2 255.0.0.0
standby 1 ip 1.0.0.3
standby 1 preempt
standby 1 authentication denmark
standby 1 timers 5 15
!
interface ethernet 1
ip address 2.0.0.2 255.0.0.0
!
router eigrp 1
network 1.0.0.0
network 2.0.0.0

The “standby ip” interface configuration command enables HSRP and establishes 1.0.0.3 as the IP address of the virtual router. The configurations of both routers include this command so that both routers share the same virtual IP address. The 1 establishes Hot Standby group 1. (If you do not specify a group number, the default is group 0.) The configuration for at least one of the routers in the Hot Standby group specifies the IP address of the virtual router; specifying the IP address of the virtual router is optional for other routers in the same Hot Standby group.

The “standby preempt” interface configuration command allows the router to become the active router when its priority is higher than all other HSRP-configured routers in this Hot Standby group. The configurations of both routers include this command so that each router can be the standby router for the other router. The 1 indicates that this command applies to Hot Standby group 1. If the “standby preempt” command in the configuration for a router is not used, then that router cannot become the active router.

The “standby priority” interface configuration command sets the router's HSRP priority to 110, which is higher than the default priority of 100. Only the configuration of Router A includes this command, which makes Router A the default active router. The 1 indicates that this command applies to Hot Standby group 1.

The “standby authentication” interface configuration command establishes an authentication string whose value is an unencrypted eight-character string that is incorporated in each HSRP multicast message. This command is optional. If you choose to use it, each HSRP-configured router in the group should use the same string so that each router can authenticate the source of the HSRP messages that it receives. The “1” indicates that this command applies to Hot Standby group 1.

The “standby timers” interface configuration command sets the interval in seconds between hello messages (called the hello time) to five seconds and sets the duration in seconds that a router waits before it declares the active router to be down (called the hold time) to eight seconds. (The defaults are three and 10 seconds, respectively.) To modify the default values, each router must be configured to use the same hello time and hold time. The “1” indicates that this command applies to Hot Standby group 1.

As shown in FIG. 2, the Backup Routing Protocol Topology Object Model, which is also a data structure, includes at least one network node object 204 representing an element in the network. The model can also include at least one network interface object 206 for each network node object 204, where the network interface object 206 represents an interface of the network element corresponding to the network node object 204. A link 230 links the network node object 204 and the network interface object 206. The model can also include an address object 212 for each at least one network interface object 206, representing an address of the corresponding interface. A link 228 links the address object 212 to the network interface object 206. FIG. 2 also shows a backup routing protocol group object 202 representing network elements organized in a backup routing protocol group. The backup routing protocol group object 202 includes a virtual address (e.g., a virtual IP address) of the corresponding backup routing protocol group and real addresses of the network elements in the backup routing protocol group. A link 220 extends between the backup routing protocol group object 202 and the address object 212, and can be formed by or based on the virtual address of the backup routing protocol group object 202. A link 232 extends between the backup routing protocol group object 202 and the network node object 204.

The model 200 can also include an address state object 216 for each of the real addresses of the network elements in the backup routing protocol group. The address state object 216 includes one or more attributes relating to a state or status of the corresponding address, including for example a priority attribute and an address state attribute The element 218 shows an exemplary enumeration or implementation of the address state, indicated for example as an Active, a Backup, or a Miscellaneous state represented by different integer values. The address state object 216 can be linked to the address object 212 via a link 222, and can be linked to the backup routing protocol group object 202 via a link 234. The model 200 can also include a tracked interface object 214 corresponding to a network interface 206 that is a tracked network interface of a first network element or node 204 in the backup routing protocol group 202. The tracked network interface can be located within the backup routing protocol group 202, or can be located between the first network element 204 and a network element outside the backup routing protocol group. The tracked interface object 214 can include, for example, a priority of the interface, and can be linked to the address state object via a link 224 and to the network interface object 206 via a link 226.

The model 200 can also include an IPv4 object 210 and an IPv6 object 208 respectively containing corresponding IP addresses, where the objects 210, 208 are linked to the address object 212. Alternatively, IPv4 and/or IPv6 addresses can be contained within attributes of the address object 212.

As can be seen from FIG. 2, an instance of the model can include multiple objects of the same type. For example, the “0..*” markings at the ends of the link 232 indicate that the backup routing protocol group 202 can be related to none, one or many network node objects 204, and each network node object 204 can be related to none, one or many backup routing protocol group objects 202. Each network node object 204 can be related to none, one or many network interface objects 206. Each network interface object 206 can be related to zero, one or many address objects 212, and each address object 212 can be related to zero or one network interface object 206. As shown in FIG. 2, the backup routing protocol group object 202 can be related to none, one or many address state objects 216, and each address state object 216 can be related to none, one or many tracked interface objects 214. FIG. 2 shows a one-to-one link between each of the following object pairs: the backup routing protocol group object 202 and the address object 212, which is consistent with each backup routing protocol group object having only one virtual IP address; the address object 212 and the address state object 216; and the tracked interface object 214 and the network interface object 206.

The objects shown in FIG. 2 can include various attributes. For example, the backup routing protocol group object 202 can include an attribute indicating a protocol type used by and/or compatible with the group corresponding to the group object 202, and can include an attribute indicating a name of the corresponding group. The network node object 204 can include an attribute indicating a name of the corresponding network node. The network interface object 206 can include an attribute indicating a status of the corresponding interface. Exemplary indications of status can be Unknown, Normal, Warning, Minor/Marginal, Major, and Critical. Other indications can alternatively or additionally be used, in various combinations. The tracked interface object 208 can include an attribute indicating a priority of the tracked interface. The address object 212 can include attributes indicating a subnet address and a virtual address, as well as operations (such as “tostring” and “getAssociatedInterface”) to indicate a failover interface (e.g., in the event the present address becomes unusable or undesirable), indicate an interface associated with the address represented by the address object 212, and so forth. In the object model 200, other attributes can additionally or alternatively be used.

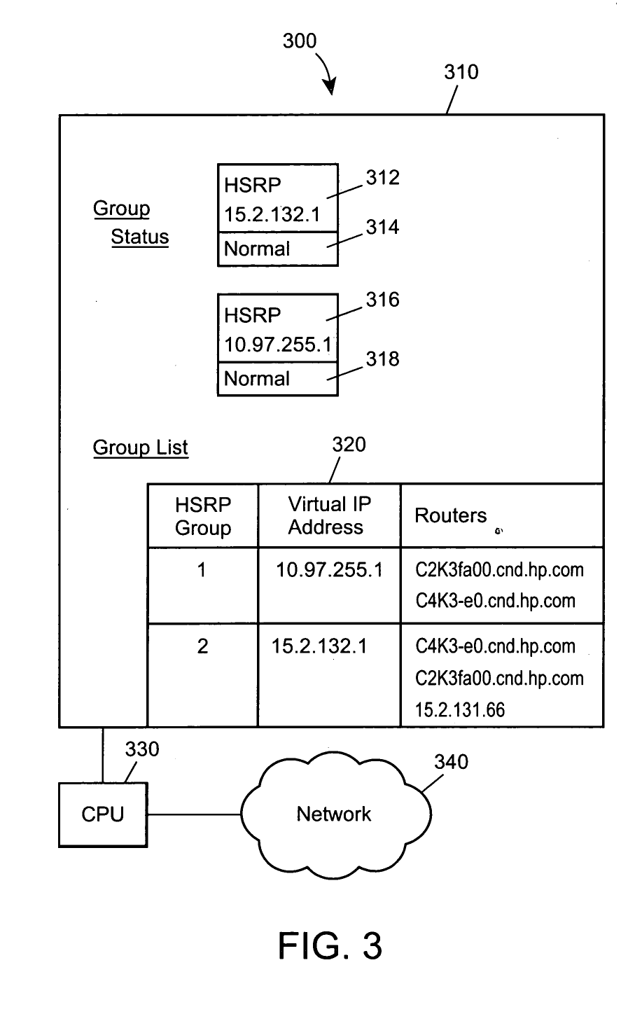

FIG. 3 illustrates an exemplary system 300, including a computer or central processing unit 330 connected to a network 340 and controlling a display 310. As shown in FIG. 3, information displayed on the display 310 can include a status indication for each group, such as an indication 314, 318 of “Normal” status as well as an identification 312, 316 of the groups. For example, the identification 312 names an HSRP Group having a virtual IP address of 15.2.132.1, and the identification 314 names an HSRP Group having a virtual IP address of 10.97.255.1. The information displayed can also include a group listing 320 which indicates for each group the virtual IP address of the group and routers belonging to the group.

For example, FIG. 3 shows HSRP Group 1 as having the virtual IP address 10.97.255.1 and routers c2k3fa00.cnd.hp.com, and c4k3-e0cnd.hp.com, and shows HSRP Group 2 as having the virtual IP address 15.2.132.1 and routers c4k3-e0.cnd.hp.com, c2k3fa00.cnd.hp.com, and 15.2.131.66. The network 340 can include the Groups shown in the information on the display 310. Various indications besides those shown in the display 310 can be used alternatively and/or additionally to convey the information regarding the Groups. For example, the indications 314, 318 of status can be colors instead of alphanumeric text. For example, the color blue can represent an Unknown status, the color green can represent a Normal status, the color cyan can represent a Warning status, the color yellow can represent Minor/Marginal status, the color Orange can represent a Major status, and the color red can represent a Critical status.

The CPU (Central Processing Unit) 330 of FIG. 3 can be used to implement one or more of: means for discovering or accessing a topology object model; means for detecting a condition of at least one backup router group in a network; and means for receiving status information and for updating the topology object model; for example via software modules or computer program(s) running on the CPU 330. A means for displaying an indication of a detected condition in the topology object model can be implemented using the display 310 of FIG. 3.

The topology model 200 or one or more instances thereof can be stored or implemented in any appropriate location, for example in a memory of the CPU 330, in a single memory or in a distributed memory within or without the network 340, in a location remote to but accessible by the CPU 330, and so forth.

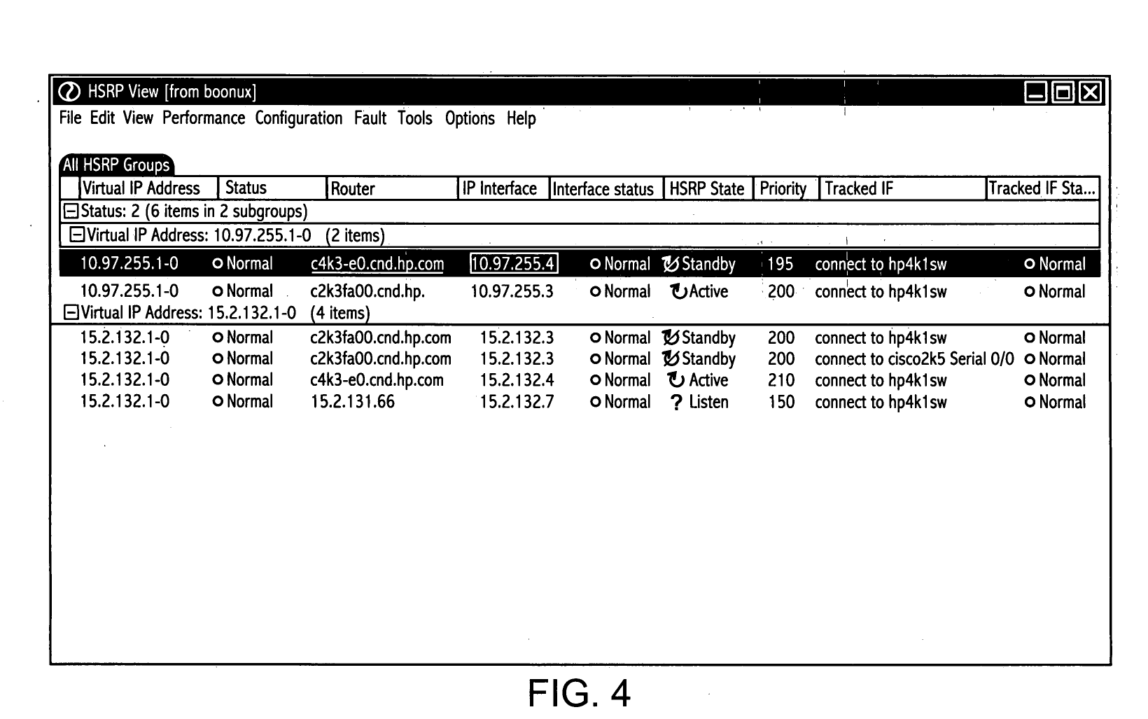

FIG. 4 shows an exemplary display of information that can be shown in the display 310, providing detailed information about one or more HSRP Groups. In particular, FIG. 4 shows detailed information for two Groups, a first Group having the virtual IP address of 10.97.255.1-0, and a second Group having the virtual IP address of 15.2.132.1-0. As shown in FIG. 4, for each Group the exemplary display includes the virtual IP address of the Group, the status of the virtual IP address, the names of each of the routers in the Group, the IP addresses of the router interfaces within the Group, status indications for the router interfaces, an HSRP state of the interface, a priority (represented for example as an integer number) of the interface and/or corresponding router, a tracked interface of the router where the tracked interface is external to the Group (e.g., interfaces the Group with a network or subnetwork external to the Group), and a status indication for the tracked interface. The status indications can include one or more of text, icons (where for example different shapes or figures and/or colors of the icons indicate status), warning lights or lamps where different colors indicate different status, and so forth. Valid HSRP states can include, for example, Active, Standby, Miscellaneous, Initial, Learn, Speak, and/or any other HSRP state. Note that the “−0” notation used herein, for example “10.97.255.1-0”, can be used by a Graphical User Interface (for example, the Graphical User Interface or display shown in FIG. 4) to show which overlapping IP address domain the virtual IP address belongs to. The same virtual IP address can be used in multiple, duplicate address domains, for example where “10.97.255.1-0” and “10.97.255.1-1” are different addresses.

In particular, FIG. 4 shows that the first Group has a virtual IP address of 10.97.255.1-0 having a “Normal” status, a router c4k3-e0.cnd.hp.com having an IP interface 10.97.255.4, an interface status of Normal, an HSRP state of Standby, a priority of 195, a tracked interface connected to hp4k1sw, and a status of Normal for the tracked interface. FIG. 4 further shows that the first group also has a router c2k3fa00.cnd.hp.com with an IP interface of 10.97.255.3, an interface status of Normal, an HSRP state of Active, a priority of 200, a tracked interface connected to hp4k1sw, and a status of Normal for the tracked interface.

FIG. 4 shows similar information for the second Group having a virtual IP address of 15.2.132.1-0. In particular, FIG. 4 shows that the second Group includes three routers, c2k3fa00.cnd.hp.com, c4k3-e0.cnd.hp.com, and 0.15.2.131.66. As shown in FIG. 4, the router c2k3fa00.cnd.hp.com has an IP interface 15.2.132.3 having an interface status of “Normal”, an HSRP State of “Standby”, and a priority of 200. FIG. 4 also shows two tracked interfaces associated with the router c2k3fa00.cnd.hp.com, namely hp4k1sw and cisco2k5 Serial0/0, both having a status indication of “Normal”. The router c4k3-e0.cnd.hp.com has an interface 15.2.132.4 having a status of “Normal”, an HSRP State of “Active”, a priority of 210, and a tracked interface hp4k1sw having a “Normal” status. FIG. 4 also shows that the router 15.2.131.66 has an IP interface 15.2.132.7 having a status of “Normal”, an HSRP State of “Listen”, a priority of 150, and a tracked interface hp4k1sw having a status of “Normal”.

One Group can be shown on the display 310, or all Groups can be shown (for example, simultaneously in the same window, or contiguously so that each can be brought into the screen window by scrolling).

The exemplary methods described herein, can be implemented using the following exemplary pseudocode:

Pseudocode for Polling Engine:

```
FOREACH HSRP group DO
    FOREACH Address in HSRP group DO
        get the cHsrpGrpStandbyState MIB
        IF cHsrpGrpStandbyState < > Address.State THEN
            Update Address.State to new state value.
            Invoke StatusAnalyzer with new state value, interface list &
            track interface list.
        ENDIF
        ...
    ENDFOREACH
ENDFOREACH
```

Pseudocode for Status Analyzer:
StatusAnalyzer (List of State, List of Interface, List of TrackInterface)
BEGIN
IF state are transient THEN
   Invoke the Poller to repoll the interface.
   Update topology with new Interface state.
ENDIF
Analyze if track interface is the cause of the failure and incorporate the track interface into the failure event.
Send event to notify user that HSRP switchover has occurred.
   END

The Polling Engine can poll each HSRP Group defined in the topology. For each HSRP Group the topology stores a list of HSRP addresses that participate in that group. Each HSRP address has a state associated with it in the topology that corresponds to the state in the HSRP MIB (Management Information Base), cHsrpGrpStandbyState. Each router can include an HSRP MIB. For each HSRP address the polling engine can read the cHsrpGrpStandbyState, for example from the MIB in the corresponding router, and compare it to the state in the topology. If the state changes then the Polling Engine can record the new state in the topology and send the new state to the Status Analyzer. The polling of the HSRP addresses can be done together so the status or status information sent to the Status Analyzer will contain all interfaces that have changed. The Polling Engine can also include if OperStatus (indication of interface operational status) of all tracked interfaces as part of the status or status information sent to the Status Analyzer. Note that the poller or Polling Engine can be configured to not send the SNMP Get operations to the interface on the router that is participating in the HSRP Group. In this case it can choose an interface on the router, which is not the interface participating in the HSRP group, as the SNMP Management address. This is done so that the Polling Engine can still make SNMP MIP queries about the state of an HSRP interface or a tracked interface when the HSRP interface is down but the router is still functional. The Polling Engine can also use ICMP (Internet Control Message Protocol) or “ping” messages to find out the state of the HSRP addresses from the router(s).

The HSRP Status Analyzer can receive status information from the polling engine, for example a list of interfaces in an HSRP group that have changed. The status analyzer can initially look at this list to see if any interfaces are in transient states. The transient states include Initial, Learn, and Speak and indicate that the poller may have polled the HSRP group while an HSRP reconfiguration was occurring. If there is an interface in a transient state then the Status Analyzer can send a request to the Polling Engine to re-poll the HSRP group. The Status Analyzer can then use the new list of interface states from this request. The logic of the Status Analyzer can be used for an Backup Routing Protocol, so the HSRP StatusAnalyzer can also be named as, or substituted by, a Backup Routing Protocol (BRP) Status Analyzer.

The HSRP address objects in the topology can be updated with the new states from the Polling Engine, by the Polling Engine and/or the HSRP Status Analyzer. After the states are updated, the Status Analyzer can set the state of the HSRP Group object in the topology based on the new states of the HSRP address objects. The HSRP status table described herein shows how the status can be calculated for the HSRP Group.

The HSRP Status Analyzer can send HSRP events after the appropriate state has been set. The HSRP Status Analyzer can check the status of the tracked interfaces to determine if a tracked interface was the cause of the event and incorporated the tracked interface information in the event.

The Polling Engine and the HSRP Status Analyzer can be implemented, for example, by the CPU 330 of FIG. 3 using software module(s) or computer program(s) running on the CPU 330. The Polling Engine can poll or otherwise obtain status information from the routers, and can access and update the topology object model. The HSRP Status Analyzer can receive status information from the Polling Engine, can access and update the topology object model, and can analyze the received status information and/or the topology object model, and can detect a condition of the backup router groups forming the topology. Accordingly, the HSRP Status Analyzer and the Polling Engine can be used to implement in various ways one or more of the means for discovering or accessing a topology model, the means for detecting a condition of the at least one backup router group, and the means for receiving status information and for updating the topology object model that are described herein.

The methods, logics, techniques and pseudocode sequences described above can be implemented in a variety of programming styles (for example Structured Programming, Object-Oriented Programming, and so forth) and in a variety of different programming languages (for example Java, C, C++, C#, Pascal, Ada, and so forth).

Those skilled in the art will appreciate that the elements and methods or processes described herein, for example the Polling Engine, the HSRP Status Analyzer, the means for discovering or accessing a topology model, the means for detecting a condition of the at least one backup router group, and the means for receiving status information and for updating the topology object model, can be implemented using a microprocessor, computer, or any other computing device, and can be implemented in hardware and/or software, in a single physical location or in distributed fashion among various locations or host computing platforms. The means for displaying an indication of the detected condition can be implemented using the display 310 of FIG. 3. Agents can be implemented in hardware and/or software or computer program(s) at any desired or appropriate location. Those skilled in the art will also appreciate that software or computer program(s) can be stored on a machine-readable medium, wherein the software or computer program(s) includes instructions for causing a computing device such as a computer, computer system, microprocessor, or other computing device, to perform the methods or processes.

It will also be appreciated by those skilled in the art that the present invention can be embodied in other specific forms without departing from the spirit or essential characteristics thereof, and that the invention is not limited to the specific embodiments described herein. The presently disclosed embodiments are therefore considered in all respects to be illustrative and not restrictive. The scope of the invention is indicated by the appended claims rather than the foregoing description, and all changes that come within the meaning and range and equivalents thereof are intended to be embraced therein.

1. A method for monitoring a network containing routers using a backup routing protocol and organized in at least one backup router group, comprising:
discovering a topology object model of the routers;
detecting a condition of the at least one backup router group based on at least one threshold value; and
displaying an indication of the detected condition.

2. The method of claim 1, wherein the at least one threshold value includes a minimum number of available routers in a backup router group.

3. The method of claim 1, wherein the detecting is also based on a number of backup router groups to which one of the routers belongs.

4. The method of claim 1, wherein for each backup router group the topology object model comprises:
at least one network router node;
at least one network interface for each at least one network router node;
at least one address for each at least one network interface;
a state of each one of the at least one address that is internal to the backup router group; and
any tracked interfaces associated with each one of the at least one address that is internal to the backup router group.

5. The method of claim 4, wherein the topology object model comprises:
a state of at least one of the at least one address that is external to the backup router group.

6. The method of claim 1, wherein the detecting is also based on a state of at least one of the at least one address that is external to the backup router group.

7. The method of claim 1, wherein the condition is a minimum number of functional routers available in a corresponding backup router group.

8. The method of claim 1, wherein the condition is a minimum number of functional routers available only in a corresponding backup router group.

9. The method of claim 1, comprising:
receiving status information from the routers; and
updating the topology object model to reflect the received status information.

10. The method of claim 9, wherein the status information includes states associated with interface addresses within the at least one backup router group.

11. The method of claim 10, wherein the status information includes status of tracked interfaces associated with routers organized in the at least one backup router group.

12. A system for monitoring a network containing routers using a backup routing protocol and organized in at least one backup router group, comprising:
means for discovering a topology object model of the routers and detecting a condition of the at least one backup router group based on at least one threshold value; and
means for displaying an indication of the detected condition.

13. The system of claim 12, wherein the at least one threshold value includes a minimum number of available routers in a backup router group.

14. The system of claim 12, wherein the detecting is also based on a number of backup router groups to which one of the routers belongs.

15. The system of claim 12, wherein for each backup router group the topology object model comprises:
at least one network router node;
at least one network interface for each at least one network router node;
at least one address for each at least one network interface;
a state of each one of the at least one address that is internal to the backup router group; and
any tracked interfaces associated with each one of the at least one address that is internal to the backup router group.

16. The system of claim 15, wherein the topology object model comprises:
a state of at least one of the at least one address that is external to the backup router group.

17. The system of claim 12, wherein the detecting is also based on a state of at least one of the at least one address that is external to the backup router group.

18. The system of claim 12, wherein the condition is a minimum number of functional routers available in a corresponding backup router group.

19. The system of claim 12, wherein the condition is a minimum number of functional routers available only in a corresponding backup router group.

20. The system of claim 12, comprising:
means for receiving status information from the routers and for updating the topology object model to reflect the received status information.

21. The system of claim 20, wherein the status information includes states associated with interface addresses within the at least one backup router group.

22. The system of claim 21, wherein the status information includes status of tracked interfaces associated with routers organized in the at least one backup router group.

23. The system of claim 12, wherein:
the means for discovering also receives status information from the routers and updates the topology object model to reflect the received status information.

24. A machine readable medium comprising a computer program for causing a computer to perform:
discovering a topology object model of the routers;
detecting a condition of the at least one backup router group based on at least one threshold value; and
displaying an indication of the detected condition.

25. The medium of claim 24, wherein the at least one threshold value includes a minimum number of available routers in a backup router group.

26. The medium of claim 24, wherein the detecting is also based on a number of backup router groups to which one of the routers belongs.

27. The medium of claim 24, wherein for each backup router group the topology object model comprises:
at least one network router node;
at least one network interface for each at least one network router node;
at least one address for each at least one network interface;
a state of each one of the at least one address that is internal to the backup router group; and
any tracked interfaces associated with each one of the at least one address that is internal to the backup router group.

28. The medium of claim 27, wherein the topology object model comprises:
a state of at least one of the at least one address that is external to the backup router group.

29. The medium of claim 24, wherein the detecting is also based on a state of at least one of the at least one address that is external to the backup router group.

30. The medium of claim 24, wherein the condition is a minimum number of functional routers available in a corresponding backup router group.

31. The medium of claim 24, wherein the condition is a minimum number of functional routers available only in a corresponding backup router group.

32. The medium of claim 24, wherein the computer program causes the computer to perform:
receiving status information from the routers; and
updating the topology object model to reflect the received status information.

33. The medium of claim 32, wherein the status information includes states associated with interface addresses within the at least one backup router group.

34. The medium of claim 33, wherein the status information includes status of tracked interfaces associated with routers organized in the at least one backup router group.

35. A data structure for representing a backup routing protocol topology object model for a network, the data structure comprising:
at least one network node object representing an element in the network;
at least one network interface object for each at least one network node object, the at least one network interface object representing an interface of the network element corresponding to the each at least one network node object;
an address object for each at least one network interface object, representing an address of the corresponding interface;
a backup routing protocol group object representing network elements organized in a backup routing protocol group, the backup routing protocol group object including a virtual address of the backup routing protocol group and real addresses of the network elements in the backup routing protocol group; and
an address state object for each of the real addresses of the network elements in the backup routing protocol group, including a state of the corresponding address.

36. The data structure of claim 35, comprising:
a track interface object corresponding to a tracked network interface of a first network element in the backup routing protocol group wherein the tracked network interface is located between the first network element and a network element outside the backup routing protocol group.

37. The data structure of claim 35, wherein:
the backup routing protocol group can be related to many network node objects;
the backup routing protocol group can be related to many address objects;
each network node object can be related to many backup routing protocol group objects;
each network node object can be related to many network interface objects;
each network interface object can be related to many address objects; and
each address object can be related to many network interface objects.
